(19) United States
(12) Patent Application Publication
(10) Pub. No.: US 2014/0075577 A1
(43) Pub. Date: Mar. 13, 2014

(54) FILE SECURITY CONTROL SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); JIE HUANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/961,893

(22) Filed: Aug. 8, 2013

(30) Foreign Application Priority Data
Sep. 10, 2012 (CN) 2012103321306

(51) Int. Cl. G06F 21/62

(52) U.S. Cl. CPC G06F 21/6209
USPC 726/29

(57) ABSTRACT

A server sets security configuration information and inserts the security configuration information into a file. The server generates a new file according to the security configuration information and the file, and displays content of the new file and operates the new file, in response to a determination that the client has authority to access and operate the new file. The server updates the security configuration information in the new file after the new file has been operated by the client.

### BACKGROUND

1. Technical Field

The embodiments of the present disclosure relate to management technology, and particularly to a file security control system and method.

2. Description of Related Art

In a company, management of files (e.g., patent application files) are important. However, at present, when a user is authorized to operate the file, the user can operate the file without restriction of times. The user can operate as many times (e.g., one hundred times) as she/he wants. For example, the user may print the file two times, copy the file to another computer twenty times, or edit the file fifty times. Thus, information security problems may occur. Therefore, there is room for improvement in the art.

### BRIEF DESCRIPTION OF THE DRAWINGS

FIG. 1 is a block view of one embodiment of a server including a file security control system.

FIG. 2 is a block diagram of one embodiment of function modules of the file security control system included in server included in FIG. 1.

FIG. 3 is a flowchart of one embodiment of a file security control method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

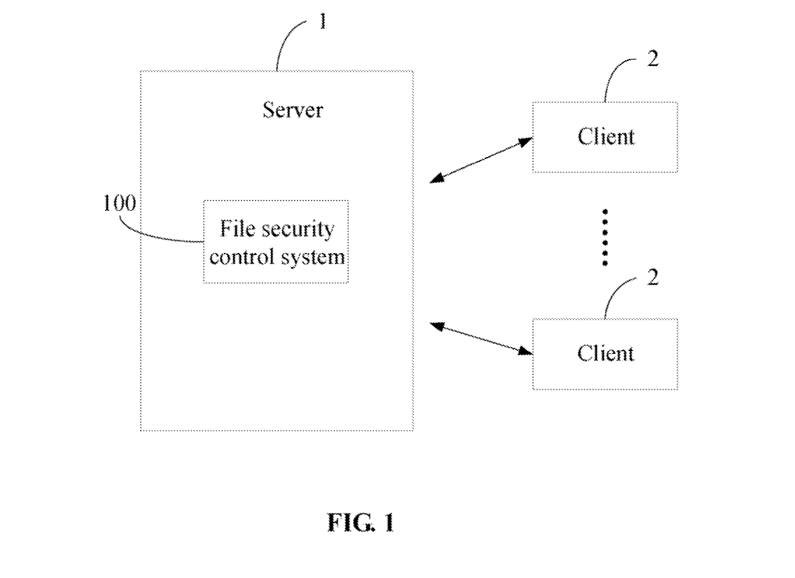

FIG. 1 is a block diagram of one embodiment of a server 1. In this embodiment, the server 1 includes a file security control system 100. The server 1 is connected to one or more clients 2 via a network (e.g., the Internet or a local area network). Each client 2 may provide a user interface, which is displayed on a display device of the client 2, for a user to access the server 1 and control one or more operations of the server 1. The user may input an ID and a password using an input device (e.g., a keyboard) into the user interface to access the server 1. The client 2 may be, but is not limited to, a mobile phone, a tablet computer, a personal computer or other data-processing apparatus.

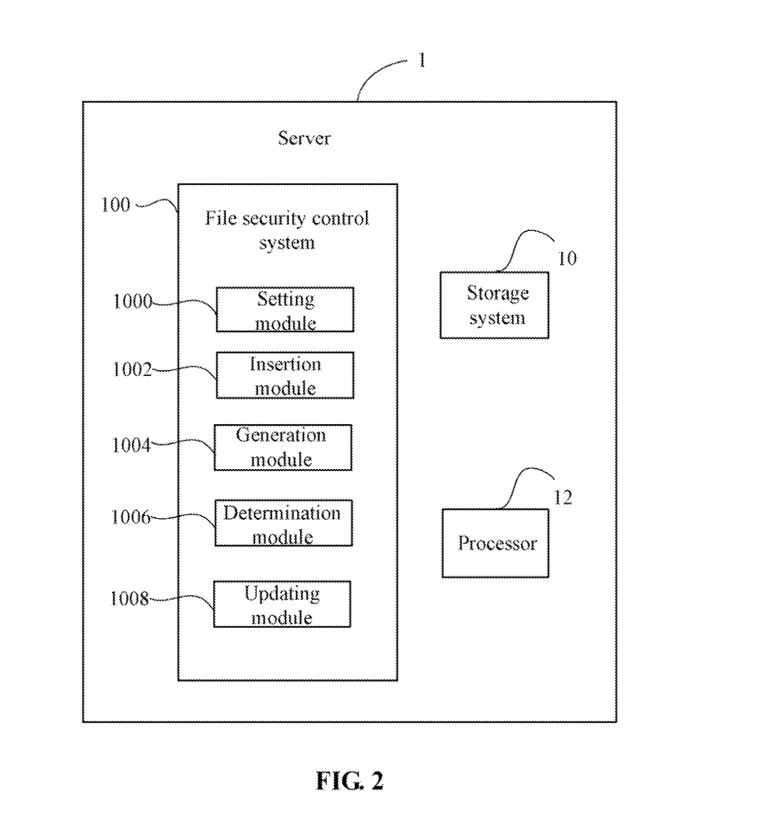

FIG. 2 is a block diagram of one embodiment of the file security control system 100 included in the server 1 of FIG. 1. The file security control system 100 controls operation of files. In one embodiment, the server 1 further includes a storage system 10 and at least one processor 12. The file security control system 100 includes a setting module 1000, an insertion module 1002, a generation module 1004, a determination module 1006, and an updating module 1008. The modules 1000-1008 may include computerized code in the form of one or more programs that are stored in the storage system 10. The computerized code includes instructions that are executed by the at least one processor 12 to provide functions for the modules 1000-1008. The storage system 10 may be a memory, such as an EPROM memory chip, hard disk drive (HDD), or flash memory stick. The files are also stored in the storage system 10.

The setting module 1000 sets security configuration information for the files stored in the server 1. In one embodiment, the security configuration information of each file includes authority setting information, access time setting information, and operation time setting information. The authority setting information includes one or more identifications (IDs), where each ID corresponds to one client 2. In one embodiment, if the ID corresponding to the client 2 is included in the authority setting information, the client 2 may have an authority to access the file. The access time setting information includes times (e.g., nine times) for accessing the file. The operation time setting information includes times (e.g., five times) for operating the file (e.g., printing the file, saving as the file, or sending the file by an e-mail). The ID corresponding to the client 2 may be, but are not limited to, a disk serial number, a globally unique identification (GUID), a network address or a time stamp.

The insertion module 1002 reads a file from the storage system 10 and inserts the security configuration information into the file. In one embodiment, the security configuration information is inserted into a header of the file. Additionally, the security configuration information may be encrypted.

The generation module 1004 generates a new file according to the security configuration information and the file. In one embodiment, the new file is integrated with the security configuration information and the file, and is converted into a new format from the original format of the file. For example, the file may be in the format of A, the new file may be converted into the format of B. Additionally, the generation module 1004 replaces the file by the new file.

The determination module 1006 determines if a client 2 has the authority to access the new file when receiving a request of accessing the new file from the client 2. In one embodiment, if the ID stored in the client 2 is included in the one or more IDs stored in the authority setting information, the client 2 is determined as having the authority to access the new file. Otherwise, if the ID stored in the client 2 is not included in the one or more IDs stored in authority setting information, the client 2 is denied access to the new file.

The determination module 1006 further determines if the client 2 has an authority to operate the new file, in response to a determination that the client 2 has the authority to access the new file. In one embodiment, the determination module 1006 determines if times of operating the new file by the client 2 exceeds the times of the operating the new file stored in the security configuration information. If the times of operating the new file by the client 2 does not exceed the times of the operating the new file stored in the security configuration information, the client 2 is determined as having the authority to operate the new file. If the times of operating the new file by the client 2 exceeds the times of the operating the new file stored in the security configuration information, the client 2 is denied to access or operate by the new file. For example, if the times of operating file is set as five times in the security configuration information, and the new file has been operated five times by the client 2, then the client 2 cannot operate the new file any more.

The updating module 1008 displays content of the new file and operates the new file. In one embodiment, the content of the new file is displayed in a displaying device of the client 2. The updating module 1008 may print, copy, or store the file.

The updating module 1008 further updates the security configuration information in the new file after the new file has been operated by the client 2. In one embodiment, when the client 2 operates the new file, the updating module 1008 accumulates the time of operating the new file by the client 2, and updates the accumulated times of operating the new file by the client 2 into the security configuration information.

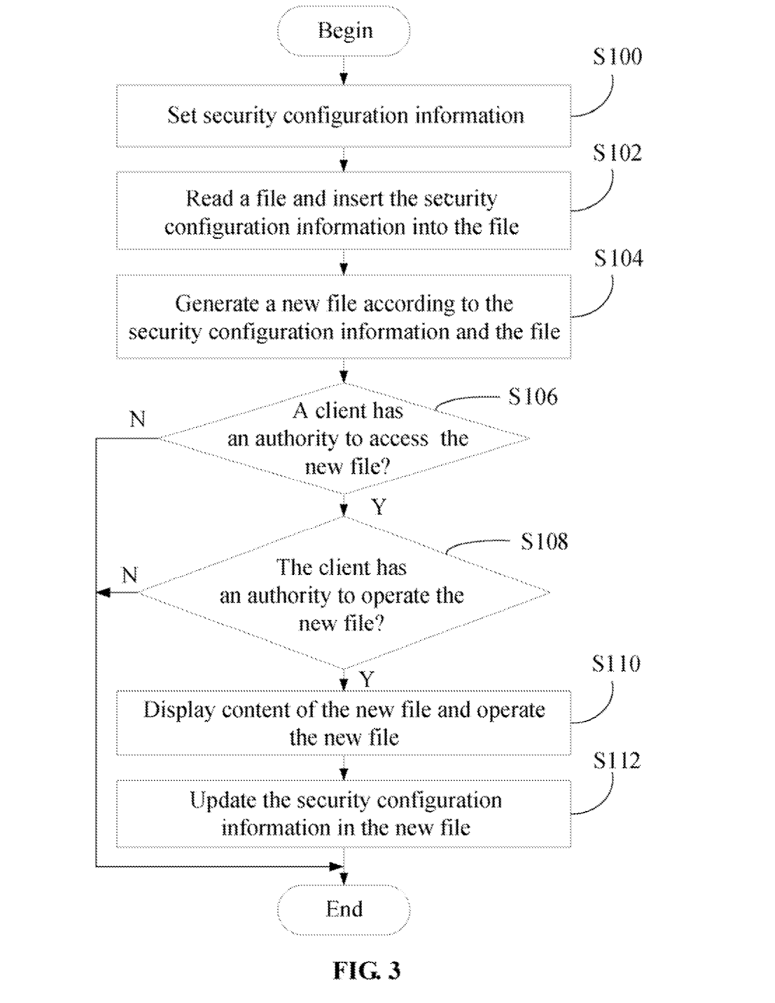

FIG. 3 is a flowchart of one embodiment of a file security control method. Depending on the embodiment, additional steps may be added, others deleted, and the ordering of the steps may be changed.

In step S100, the setting module 1000 sets security configuration information in the server 1. In one embodiment, the security configuration information includes one or more identifications (ID), times (e.g., nine times) for accessing the file, and times (e.g., five times) for operating the file (e.g., printing the file, saving as the file, or sending the file in format of e-mail). As mentioned above, each ID corresponds to one client 2, and the ID corresponding to the client 2 may be, but are not limited to, a disk serial number, a globally unique identification (GUID), a network address or a time stamp.

In step S102, the insertion module 1002 reads the file from the storage system 10 and inserts the security configuration information into the file. In one embodiment, the security configuration information may be encrypted using a symmetric key encryption or an asymmetric key encryption, and the encrypted security configuration information is inserted into a header of the file.

In step S104, the generation module 1004 generates a new file according to the security configuration information and the file. In one embodiment, the new file is converted into a new format from the original format of the file. The new file is integrated with the security configuration information and the file. For example, the file may be in the format of A, the new file may be converted into the format of B. Additionally, the file is replaced by the new file when the new file is generated.

In step S106, the determination module 1006 determines if a client 2 has an authority to access the new file when receiving a request of accessing the new file from the client 2. In one embodiment, if the ID stored in the client 2 is included in the one or more IDs stored in the authority setting information, the client 2 has the authority to access the new file, the procedure goes to step 5108. Otherwise, if the ID stored in the client 2 is not included in the one or more IDs stored in authority setting information, the client 2 is denied to access the new file, the procedure ends.

In step S108, the determination module 1006 further determines if the client 2 has an authority to operate the new file. In one embodiment, if the times of operating the new file by the client 2 does not exceed the times of the operating the new file stored in the security configuration information, the client 2 is determined as have the authority to operate the new file, the procedure goes to step S110. If the times of operating the new file by the client 2 exceeds the times of the operating the new file stored in the security configuration information, the client 2 is denied to access or operate the new file, the procedure ends.

In step S110, the updating module 1008 displays content of the new file and operates the new file. In one embodiment, the content of the new file is displayed in a displaying device of the client 2. The updating module 1008 may amend the content of the new file, or print the new file.

In step S112, the updating module 1008 further updates the security configuration information in the new file after the new file has been operated by the client 2. In one embodiment, each time when the client 2 operates the new file, the updating module 1008 calculates the times of operating the new file by the client 2, and updates the ID of the client 2 and the times of the operating the new file into the security configuration information.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server in electronic communication with a client, comprising:
at least one processor; and
a storage system that stores one or more programs, when executed by the at least one processor, cause the at least one processor to perform a file security control method, the method comprising:
setting security configuration information for a file stored in the storage system;
reading the file from the storage system and inserting the security configuration information into the file;
generating a new file according to the security configuration information and the file;
when receiving a request of accessing the new file from the client, determining whether the client has an authority to access the new file, and determining whether the client has an operation authority to operate the new file in response to a determination that the client has the authority to access the new file;
displaying content of the new file and operating the new file, in response to a determination that the client has the authority to operate the new file; and
updating the security configuration information in the new file after the new file has been operated by the client.

2. The server of claim 1, wherein the security configuration information comprises one or more identifications (IDs), times for accessing the file, and times for operating the file.

3. The server of claim 2, wherein each ID corresponds to one client and the ID corresponding to the client is selected from a group consisting of a disk serial number, a globally unique identification, a network address and a time stamp.

4. The server of claim 1, wherein the security configuration information is inserted into a header of the file.

5. The server of claim 2, wherein the client is determined as having the authority to access the new file upon the condition that the ID stored in the client is included in the one or more IDs stored in the authority setting information.

6. The server of claim 2, wherein the client is determined as having the authority to operate the new file upon the condition that the times of operating the new file by the client does not exceed the times of the operating the new file stored in the security configuration information.

7. A file security control method implemented by a server, the server in electronic communication with a client, the method comprising:
setting security configuration information for a file stored in a storage system of the server;
reading the file from the storage system and inserting the security configuration information into the file;
generating a new file according to the security configuration information and the file;
when receiving a request of accessing the new file from the client, determining whether the client has an authority to access the new file, and determining whether the client has an operation authority to operate the new file in response to a determination that the client has the authority to access the new file;
displaying content of the new file and operating the new file, in response to a determination that the client has the authority to operate the new file; and
updating the security configuration information in the new file after the new file has been operated by the client.

8. The method of claim 7, wherein the security configuration information comprises one or more identifications (IDs), times for accessing the file, and times for operating the file.

9. The method of claim 8, wherein each ID corresponds to one client and the ID corresponding to the client is selected from a group consisting of a disk serial number, a globally unique identification, a network address and a time stamp.

10. The method of claim 7, wherein the security configuration information is inserted into a header of the file.

11. The method of claim 8, wherein the client is determined as having the authority to access the new file upon the condition that the ID stored in the client is included in the one or more IDs stored in the authority setting information.

12. The method of claim 8, wherein the client is determined as having the authority to operate the new file upon the condition that the times of operating the new file by the client does not exceed the times of the operating the new file stored in the security configuration information.

13. A non-transitory computer-readable medium having stored thereon instructions that, when executed by a server, the server in electronic communication with a client, causing the cloud server to perform a file security control method, the method comprising:
setting security configuration information for a file stored in a storage system of the server;
reading the file from the storage system and inserting the security configuration information into the file;
generating a new file according to the security configuration information and the file;
when receiving a request of accessing the new file from the client, determining if the client has an authority to access the new file, and determining if the client has an operation authority to operate the new file in response to a determination that the client has the authority to access the new file;
displaying content of the new file and operating the new file, in response to a determination that the client has the authority to operate the new file; and
updating the security configuration information in the new file after the new file has been operated by the client.

14. The non-transitory computer-readable medium of claim 13, wherein the security configuration information comprises one or more identifications (IDs), times for accessing the file, and times for operating the file.

15. The non-transitory computer-readable medium of claim 14, wherein each ID corresponds to one client and the ID corresponding to the client is selected from a group consisting of a disk serial number, a globally unique identification, a network address and a time stamp.

16. The non-transitory computer-readable medium of claim 13, wherein the security configuration information is inserted into a header of the file.

17. The non-transitory computer-readable medium of claim 14, wherein the client is determined as having the authority to access the new file upon the condition that the ID stored in the client is included in the one or more IDs stored in the authority setting information.

18. The non-transitory computer-readable medium of claim 14, wherein the client is determined as having the authority to operate the new file upon the condition that the times of operating the new file by the client does not exceed the times of the operating the new file stored in the security configuration information.
